(19) United States
(12) Patent Application Publication
(10) Pub. No.: US 2011/0180379 A1
(43) Pub. Date: Jul. 28, 2011

(54) SWITCH MODULE WITH LIGHTED KEY

(75) Inventors: Yoshimasa Osumi, Kyoto (JP); Tomonobu Kato, Shiga (JP); Katsuyuki Tsukiyama, Osaka (JP); Mitsuru Okuda, Shiga (JP)

(73) Assignee: OMRON CORPORATION, Kyoto-shi, Kyoto (JP)

(21) Appl. No.: 13/059,210

(22) PCT Filed: Jul. 22, 2009
(86) PCT No.: PCT/JP2009/003436

§ 371 Date: Apr. 6, 2011

(30) Foreign Application Priority Data
Aug. 21, 2008 (JP) 2008-212546

(51) Int. Cl. H01H 1/10

(52) U.S. Cl. 200/516

(57) ABSTRACT

A switch module with lighted key has a cover sheet having an adhesive layer on a rear surface, a dome-shaped contact spring adhered on a rear surface of the cover sheet by the adhesive layer, a substrate including a fixed contact switched to an electrically conducted state or an insulated state with the contact spring, and a light guide sheet arranged on a front surface side of the cover sheet. One or more recesses are formed in a region facing the contact spring of at least one of a front surface and a rear surface of the light guide sheet so as not to penetrate toward a surface on an opposite side.

### BACKGROUND OF THE INVENTION

1. Technical Field

The present invention relates to a switch module with lighted key. Specifically, the present invention relates to a switch module with lighted key for a switch with lighted key used by being incorporated in a mobile telephone, a digital audio, and the like.

2. Background Art

Mobile telephones and the like use a key switch having a structure in which a key (input button) is pushed with a finger so that a contact spring is elastically deformed on the rear surface side, thereby electrically conducting the contact spring to a fixed contact and turning ON the switch. Some of such key switches are called a switch with lighted key in which the surface where the keys are arrayed is illuminated from the rear surface side using a light guide sheet.

FIG. 1 is a schematic cross-sectional view showing the structure of a conventionally known switch with lighted key, and shows one part of the switch with lighted key. In the switch with lighted key 11, a dome shaped contact spring 12 is arranged on a board 14 so as to cover a fixed contact 13, and a cover sheet 15 is overlapped on the contact spring 12 to hold the contact spring 12. A light guide sheet 16 made of transparent resin is further overlapped thereon, and a key 17 is arranged thereon. The light from the light source is guided to the light guide sheet 16, and the surface where the key 17 is arrayed is illuminated from the rear surface side by the light leaking from the light guide sheet 16.

(Lowering in Click Feeling)

However, if the flexible light guide sheet 16 is sandwiched between the key 17 and the contact spring 12 as in the switch with lighted key 11 of FIG. 1, the click feeling (operation feeling when pushing in the key) when the key 17 is pushed with the finger tends to become worse. The click feeling of the key 17 is obtained when the dome shaped contact spring 12 is pushed, and the contact spring 12 is buckled and squashed when a certain pushing force is exceeded. The click feeling obtained in such a manner lowers because if the light guide sheet 16 exists under the key 17, an elastic rebound stress G2 is generated in the light guide sheet 16 by a force G1 of the key 17 pushing the light guide sheet 16 when the key 17 is pushed, the force is not efficiently transmitted to the contact spring 12 by such an amount, and an extra force is required for the operation of the key 17 thereby worsening the operation feeling.

According to an experiment, the click rate when the key 17 is pushed was 33% when the light guide sheet 16 does not exist at the lower surface of the key 17, whereas the click rate was lowered to 25% when the light guide sheet 16 made of polycarbonate resin having a thickness of 125 μm was inserted, and the click rate was lowered to 27% when the light guide sheet 16 made of polycarbonate resin having a thickness of 100 μm was inserted. This is summarized in Table 1.

TABLE 1

| Light guide sheet | None | Thickness of 125 μm | Thickness of 100 μm |
|---|---|---|---|
| Click rate | 33% | 25% | 27% |

The click rate was calculated in the following manner. A large load was gradually applied to the key at an area immediately above the contact spring in each sample, and the displacement of the vertex of the contact spring at the time was measured. FIG. 2 shows the relationship of the load and the displacement in a certain sample at this time, where the load becomes greater toward the upper side of the vertical axis, and the displacement to the lower side of the vertex of the contact spring becomes greater toward the right of the horizontal axis. When load is gradually increased, the contact spring elastically deforms thereby carrying out the click operation when a certain load is reached, and hence the load (operation load) F1 at the start of the click operation is measured. When the load is gradually decreased from the state in which the click operation is terminated and the contact spring is elastically deformed, the contact spring elastically returns at a certain load, and hence the load (return load) F2 at the time of elastic return is measured. The click rate is calculated with the following equation using the operation load F1 and the return load F2 measured as above.

Click rate K[%]=100×(F1−F2)/F1

The feeling at the time of clicking becomes better the greater the value of the click rate K.

(Use of Flexible Light Guide Sheet)

In Patent Document 1, a material of high flexibility such as silicone and polyurethane is used for the material of the light guide sheet to improve the lowering of the click feeling. If the light guide sheet made of material having high flexibility is used, the elastic rebound stress from the light guide sheet to the key can be reduced and the force can be efficiently transmitted to the contact spring, thereby improving the click feeling.

In the method of Patent Document 1, however, as a result of using a flexible material such as silicone and polyurethane for the light guide sheet, (1) unit price as the material of the light guide sheet rises, (2) performance (transmissivity, flatness, etc.) as an optical component of the light guide sheet lowers, and (3) workability of the light guide sheet becomes unsatisfactory due to its flexibility and accurately forming a dimple for controlling the light becomes difficult. As a result, in the method of Patent Document 1, the cost of the light guide sheet is high, and the optical performance as the backlight for the switch with lighted key of the light guide sheet is greatly degraded.

(Through-Hole of Light Guide Sheet)

Another method of improving the lowering of the click feeling is a method of providing a through-hole 19 in the light guide sheet 16 in the region facing the contact spring 12, as show in FIGS. 3(a) and 3(b). If the through-hole 19 is arranged in the light guide sheet 16 as in the switch with lighted key 18, the elastic rebound stress of the light guide sheet 16 can be reduced, and thus the click feeling can be improved.

Patent Document 2 discloses a method in which the lowering of the click feeling is improved by providing the through-hole. The method disclosed in Patent Document 2, however, provides an arcuate through-hole in an EL sheet in the vicinity of the region facing the contact spring.

If the through-hole 19 is formed in the light guide sheet 16 to improve the click feeling, light L (shown with an arrow) that reached the through-hole 19 from the light source passes through the through-hole 19 so that the advancing direction is bent or totally reflected at the outer peripheral surface of the through-hole 19 as shown in FIG. 4(a), or the light L leaks to the outside from the through-hole 19 as shown in FIG. 4(b). Thus, the light L from the light source is blocked by the through-hole 19, and the light is less likely to reach in the direction of the back of the through-hole 19, or a bright point or a bright line occurs by the leaked light. As a result, the optical performance of the light guide sheet 16 greatly degrades and the surface where the key is arrayed becomes difficult to be irradiated with an even amount of light.

Patent Document 1: Japanese Unexamined Patent Publication No. 2007-324100

Patent Document 2: Japanese Unexamined Patent Publication No. 2002-56737

### SUMMARY

One or more embodiments of the present invention provides a switch module with lighted key capable of alleviating an elastic rebound stress of a light guide sheet, which is the cause of lowering of a click feeling, and improving the click feeling while maintaining high optical performance for a back light for illuminating the key from the back.

According to one or more embodiments of the present invention, a switch module with lighted key includes a cover sheet having an adhesive layer on a rear surface, a dome-shaped contact spring adhered on the rear surface of the cover sheet by the adhesive layer, a substrate including a fixed contact switched to an electrically conducted state or an insulated state with the contact spring, and a light guide sheet arranged on a front surface side of the cover sheet; wherein a recess is formed in a region facing the contact spring of at least one of a front surface or a rear surface of the light guide sheet so as not to penetrate toward a surface on an opposite side.

The switch module with lighted key according to one or more embodiments of the present invention has a recess that does not penetrate to the surface on the opposite side formed in the region facing the contact spring, and thus at least one part of the region facing the contact spring can be thinned so that the elasticity of the light guide sheet can be reduced and the elastic rebound stress when the light guide sheet is pushed with the key can be reduced. The force of pushing the key with the finger is thus efficiently transmitted to the contact spring, and the click feeling when the key is pushed can be improved.

Furthermore, since the recess does not penetrate through the light guide sheet, the light can pass through the region formed with the recess through the thin thickness portion, and thus the back of the recess or the like is unlikely to become dark. The light is less likely to leak out from the recess by forming the depth of the recess shallow to about a fraction of the thickness of the light guide sheet, whereby bright lines and bright points are less likely to occur by the light leaked from the recess.

As a result, according to one or more embodiments of the present invention, the click feeling when the key is pushed can be improved without lowering the optical performance of the light guide sheet.

The recess in the switch module with lighted key according to one or more embodiments of the present invention is arranged to be point symmetric with respect to a point corresponding to a center of the contact spring of the light guide sheet.

The recess in the switch module with lighted key according to one or more embodiments of the present invention is arranged to be line symmetric with respect to a virtual line passing through a point corresponding to a center of the contact spring of the light guide sheet.

According to the above in which the recess is arranged point symmetrically or line symmetrically, the elastic rebound stress generated in the light guide sheet when the key is pushed can be made even, and the click feeling can be improved.

The recess in the switch module with lighted key according to one or more embodiments of the present invention includes an annular groove of a circular ring shape having a constant width. According to one or more embodiments of the present invention, the annular groove can be formed along the area of large elastic rebound stress when pushed with the key.

In the switch module with lighted key according to one or more embodiments of the present invention, an inner diameter of the annular groove is greater than or equal to 0.5 times and smaller than or equal to 0.6 times a diameter of the contact spring. The region where the elastic rebound stress generated in the light guide sheet takes a local maximum value is a region having a diameter of 0.6 times the diameter of the contact spring, and the width of the annular groove is desirably greater than or equal to 200 μm, and thus the annular groove can be arranged in accordance with the region where the elastic rebound stress takes a local maximum value by setting the inner diameter (diameter) of the annular groove to greater than or equal to 0.5 times and smaller than or equal to 0.6 times the diameter of the contact spring.

In the switch module with lighted key according to one or more embodiments of the present invention, the annular groove is formed on a surface on a side the switch of the light guide sheet is arranged. According to the simulation result, the effect of improving the click rate is greater if the annular groove is arranged on the surface (i.e. front surface) on the side the switch is arranged of the light guide sheet rather than when arranged on the rear surface.

In the switch module with lighted key according to one or more embodiments of the present invention, the recess includes a linear recessed groove having a constant width. According to the above, the light of the light source is less likely to be blocked by the recessed groove and the optical performance of the light guide sheet can be enhanced by arranging the longitudinal direction of the recessed groove titled toward the light source side.

In the switch module with lighted key according to one or more embodiments of the present invention, the recessed groove is formed on a surface on a side the contact spring of the light guide sheet exists. According to the actual measurement result, the effect of improving the click rate is greater if the linear recessed groove is arranged on the surface (i.e. rear surface) on the side the contact spring exists of the light guide sheet rather than when arranged on the front surface.

In the switch module with lighted key according to one or more embodiments of the present invention, the recessed groove has a length of greater than or equal to 0.5 times the diameter of the contact spring. According to the actual measurement result, the elastic rebound stress of the light guide sheet can be reduced by having the length of the recessed groove to greater than or equal to 0.5 times the diameter of the contact spring.

In the switch module with lighted key according to one or more embodiments of the present invention, a groove width of the recess (i.e., annular groove or recessed groove) is greater than or equal to 200 μm. According to the simulation result or the actual measurement result, it was found that the click rate can be improved by setting the groove width to greater than or equal to 200 μm.

In the switch module with lighted key according to one or more embodiments of the present invention, a groove cross-sectional shape of the recess (i.e., annular groove or recessed groove) is a trapezoidal shape or a triangular shape. The light that entered the side surface of the recess is totally reflected so as to less be unlikely to leak out if the groove cross-sectional shape of the recess has a trapezoidal shape or a triangular shape, whereby bright lines and bright points are less likely to occur.

In the switch module with lighted key according to one or more embodiments of the present invention, a width of the groove is greater than a depth of the groove at a groove cross-section of the recess (i.e., annular groove or recessed groove). This is because the effect of improving the click feeling is higher if the width of the groove is greater than the depth of the groove.

In the switch module with lighted key according to one or more embodiments of the present invention, the recessed groove is arranged so that a longitudinal direction is parallel to a line segment connecting a position of the recessed groove and a position of a light source. According to the above, the optical performance of the light guide sheet is enhanced since the light of the light source is less likely to be blocked by the recessed groove. Furthermore, the bright lines and bright points are less likely to occur by the light leaked from the side surface since the light is less likely to enter the side surface of the recessed groove.

In the switch module with lighted key according to one or more embodiments of the present invention, a groove portion for optical path conversion for changing a direction of light advancing toward a distal end of a recessed groove is arranged at a position closer to a light source than the recessed groove adjacent to the recessed groove. According to the above, the direction of the light advancing toward the distal end of the recessed groove can be changed by the groove portion for optical path conversion, and thus the bright points and the bright lines can be prevented from occurring by the light leaked from the distal end of the recess.

### BRIEF DESCRIPTION OF THE DRAWINGS

FIG. 1 is a schematic cross-sectional view showing a structure of a conventionally known switch with lighted key.

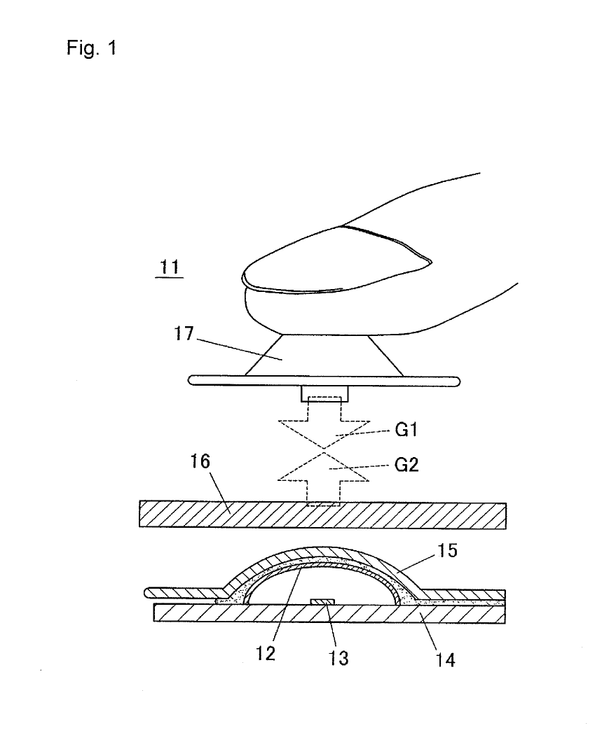

FIG. 2 is a view describing the definition of a click rate K.

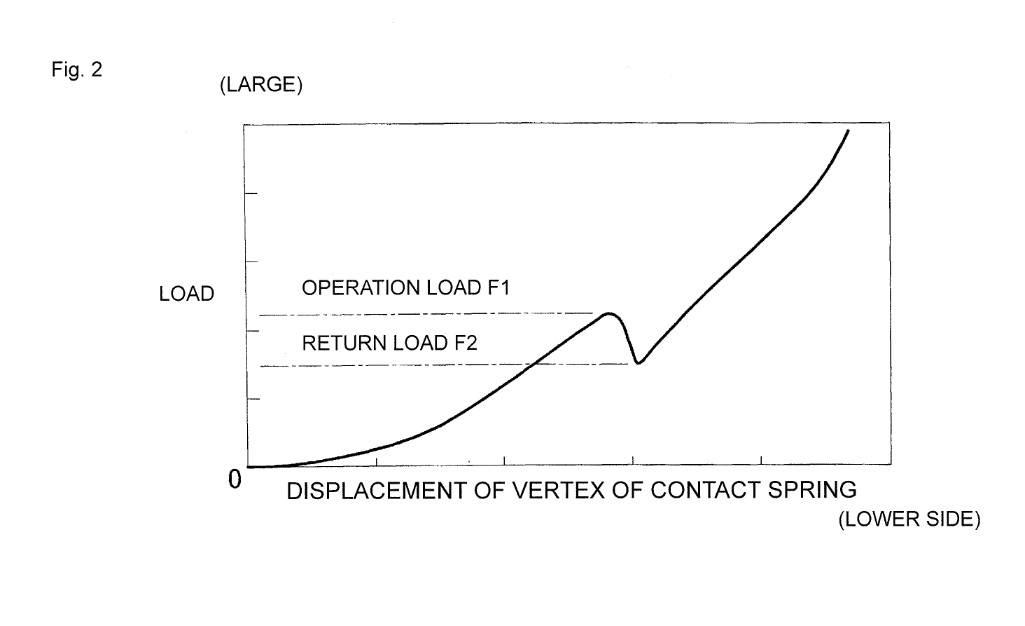

FIG. 3(a) is a schematic cross-sectional view of the switch with lighted key in which a circular through-hole is formed in a light guide sheet, and FIG. 3(b) is a plan view showing one part of the light guide sheet formed with a circular through-hole.

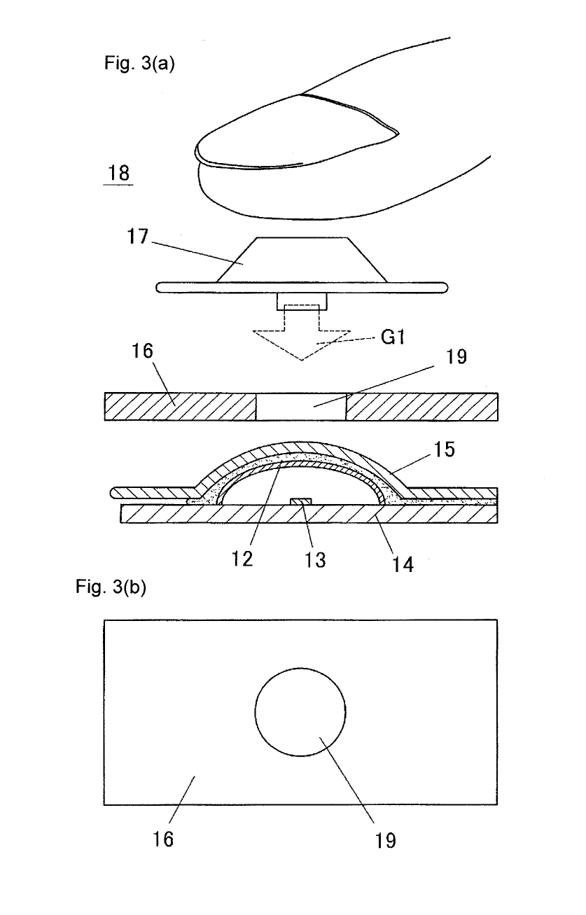

FIGS. 4(a) and 4(b) are schematic views showing a state in which the advancing direction of light is bent by the circular through-hole or the light is leaked.

FIG. 5 is an exploded perspective view of a switch module with lighted key according to a first embodiment of the present invention.

FIG. 6(a) is a schematic cross-sectional view of a switch with lighted key (one unit portion) of the first embodiment, and FIG. 6(b) is a plan view showing a portion of the light guide sheet used in the switch with lighted key.

FIG. 7 is an explanatory view of the effect of the switch with lighted key according to the first embodiment.

FIG. 8 is a schematic cross-sectional view showing a state in which a contact spring and the light guide sheet are deformed when the key is pushed.

FIGS. 9(a) and 9(b) are a plan view and a schematic cross-sectional view for describing a state in which the light that reached an annular groove passes a thin thickness portion below the annular groove.

FIG. 10 is a view showing a result of simulating the displacement amount of each point of the light guide sheet when the key is pushed in.

FIG. 11 is a view showing a result of simulating the magnitude of an elastic rebound stress generated at the rear surface of the light guide sheet when the key is pushed in.

FIG. 12 is a view showing the relationship between the groove width of the annular groove provided on the front surface or the rear surface of the light guide sheet, and the improvement point of the click rate.

FIG. 13(a) is a schematic cross-sectional view showing a switch with lighted key (one unit portion) according to a variant of the first embodiment, and FIG. 13(b) is a plan view showing one portion of the light guide sheet thereof.

FIG. 14(a) is a schematic cross-sectional view showing a switch with lighted key (one unit portion) according to another variant of the first embodiment, and FIG. 14(b) is a plan view showing one portion of the light guide sheet thereof.

FIG. 15(a) is a schematic cross-sectional view showing a switch with lighted key (one unit portion) according to still another variant of the first embodiment, and FIG. 15(b) is a rear view showing one portion of the light guide sheet thereof.

FIG. 16(a) is a schematic cross-sectional view showing a switch with lighted key (one unit portion) according to yet another variant of the first embodiment, and FIG. 16(b) is a rear view showing one portion of the light guide sheet thereof.

FIG. 17(a) is a schematic cross-sectional view showing a switch with lighted key (one unit portion) according to a second embodiment of the present invention, and FIG. 17(b) is a rear view showing one portion of the light guide sheet used in the switch with lighted key.

FIG. 18 is a view for describing the manner of arranging a recessed groove in the second embodiment.

FIG. 19 is a view showing a recessed groove in the second embodiment.

FIG. 20 is a view showing a result of actually measuring the relationship of the groove width of the recessed groove arranged on the front surface or the rear surface of the light guide sheet, and the improvement point of the click rate.

FIG. 21 is a view showing a result of actually measuring the relationship of the length of the recessed groove and the elastic repulsion stress in the light guide sheet provided with the recessed groove having a V-shaped cross section and in the light guide sheet provided with the recessed groove having a semicircular cross-section.

FIG. 22 is a view showing a result of actually measuring the relationship of the number of recessed grooves arranged on the front surface or the rear surface of the light guide sheet, and the improvement point of the click rate.

FIG. 23 shows a result of actually measuring the relationship of the width of the recessed groove having a semicircular cross-section, and the improvement point of the click rate.

FIG. 24 is a view comparing the improvement point of the recessed groove having a square cross-section and the recessed groove having a semicircular cross-section with the same groove width.

FIG. 25 is a view describing the manner of arranging the recessed groove according to a variant of the second embodiment.

FIG. 26(a) is a schematic cross-sectional view showing a switch with lighted key (one unit portion) according to another variant of the second embodiment, and FIG. 26(b) is a rear view showing one portion of the light guide sheet used in the switch with lighted key.

FIGS. 27(a) and 27(b) are a perspective view and a front view showing a shape of the recessed groove in a switch with lighted key according to a third embodiment of the present invention, FIGS. 27(c), 27(d), and 27(e) are a cross-sectional view taken along line X-X, a cross-sectional view taken along line Y-Y, and a cross-sectional view taken along line Z-Z of FIG. 27(a).

FIGS. 28(a) and 28(b) are a cross-sectional view and a plan view showing a shape of the recessed groove according to a variant of the third embodiment.

FIGS. 29(a) and 29(b) are a plan view and a perspective view showing a shape of the recessed groove according to another variant of a third embodiment.

FIGS. 30(a), 30(b), and 30(c) are a plan view, a rear view, and a cross-sectional view showing the light guide sheet used in a switch with lighted key according to a fourth embodiment of the present invention.

FIGS. 31(a) and 31(b) are a front view and a rear view showing the light guide sheet according to a variant of the fourth embodiment of the present invention.

### DESCRIPTION OF SYMBOLS

21 switch module with lighted key
22 printed circuit board
23 contact spring
24 cover sheet
25 light guide sheet
26a fixed contact
26b annular contact section
27 adhesive layer
28 annular groove
29 light incident section
30 light source
34 key top
35 key sheet
36 key
37 pushing element
41 switch with lighted key
42 recess
43 recess
51 switch with lighted key
52 recessed groove
53 recessed groove

### DETAILED DESCRIPTION

Embodiments of the present invention will be hereinafter described with reference to the accompanied drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

### First Embodiment

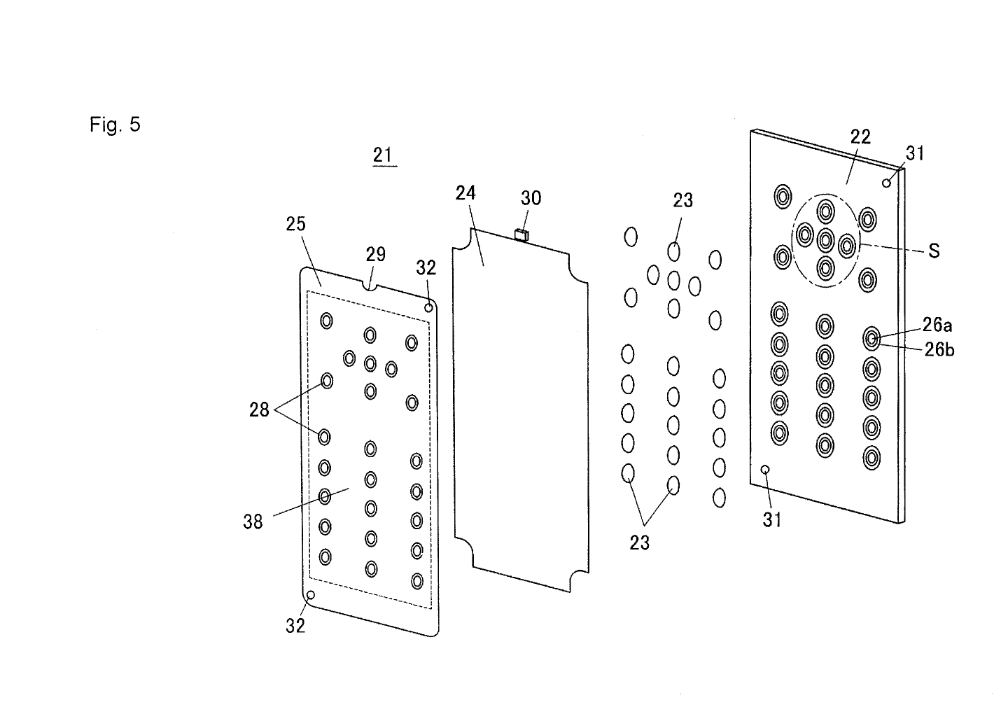

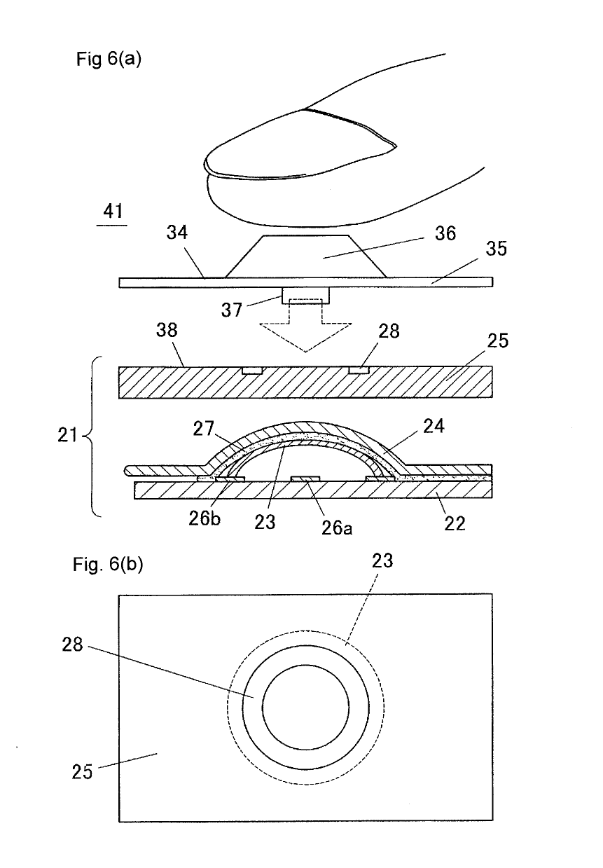

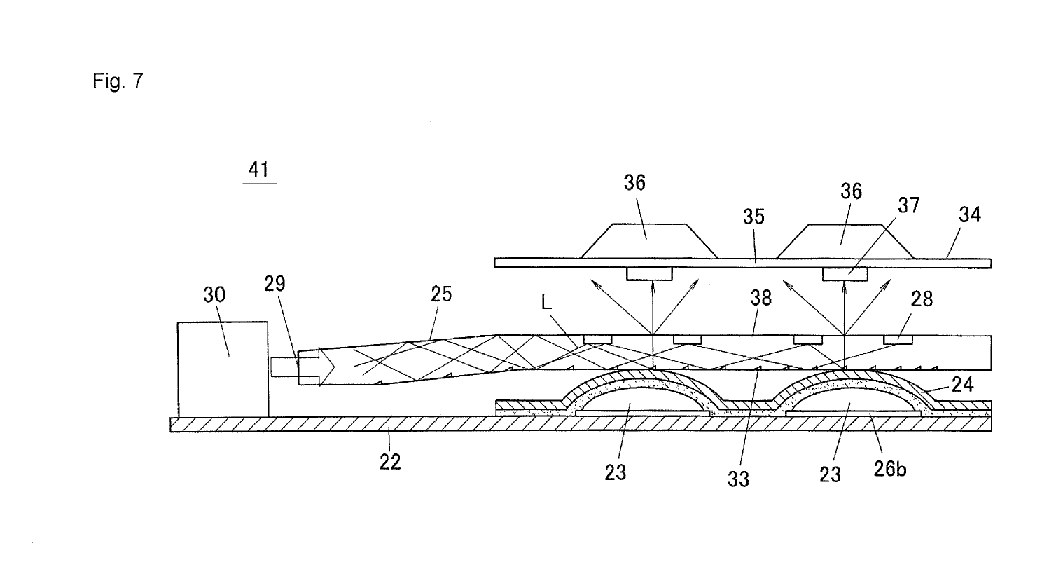

A structure of a switch with lighted key or a switch module with lighted key according to a first embodiment of the present invention will be described with reference to FIG. 5 to FIG. 7. FIG. 5 is an exploded perspective view of a switch module with lighted key 21 according to the first embodiment. FIG. 6(a) is a schematic cross-sectional view of a switch with lighted key 41 in which a key top is added to the switch module with lighted key 21, and shows a region (hereinafter referred to as one unit portion) including one contact spring 23. FIG. 6(b) is a plan view of a light guide sheet 25 used in the switch with lighted key 41. FIG. 7 is a schematic view for describing the effect of the switch with lighted key 41.

As shown in FIG. 5, the switch module with lighted key 21 includes a printed circuit board 22 (board) including a flexible printed board, a contact spring 23, a cover sheet 24, and a light guide sheet 25. A plurality of circular fixed contacts 26a made of a conductive material are arranged on the front surface of the printed circuit board 22, and an annular contact section 26b surrounding the fixed contact 26a is arranged around each fixed contact 26a. An insulating gap exists between the fixed contact 26a and the annular contact section 26b. The printed circuit board 22 includes a positioning hole 31 at the corner.

The contact spring 23 is formed in a convex dome shape by a metal thin plate material having conductivity and elasticity, in particular, by a stainless material, where the rear surface side is depressed in a bowl shape. The diameter of the contact spring 23 is greater than the inner diameter of the annular contact section 26b, and smaller than the outer diameter of the annular contact section 26b.

The cover sheet 24 has the function to hold the contact spring 23 and serves as a reflection sheet of the light guide sheet 25. Therefore, the cover sheet 24 is configured by a thin and flexible resin sheet, particularly a white resin sheet having high reflectance. An adhesive layer 27 (see FIG. 6) of even thickness is provided on the rear surface of the cover sheet 24 by an adhesive. In the figure, the adhesive layer 27 is applied over substantially the entire surface of the rear surface of the cover sheet 24 but the adhesive layer 27 may not be applied to the region facing the base of the contact spring 23 and may be applied only to the region facing the vertex portion of the contact spring 23, and the like.

The light guide sheet 25 is molded to a sheet form by a transparent resin material having high index of refraction, and has flexibility. The material of the light guide sheet 25 may be polycarbonate resin, acrylic resin, polyethylene terephthalate (PET) and the like having optically high performance. One end of the light guide sheet 25 is provided with a light incident portion 29 cut out to an arcuate shape, where a light source 30 such as an LED is arranged at a position facing the light incident portion 29. A positioning hole 32 that forms a pair with the positioning hole 31 is formed at the corner of the light guide sheet 25.

The design for satisfying the optical performance as the backlight is performed in a pattern area surrounded with a broken line in the light guide sheet 25. In other words, a microscopic diffusion pattern (not shown) of a few dozen μm to a few hundred μm is formed on the front surface (light exit surface 38) of the light guide sheet 25, and a number of very thin light deflection patterns 33 (dimples) (see FIG. 7) having a triangular prism shape, a conical shape, a semispherical shape, and the like is arranged on the rear surface (surface facing the cover sheet 24) of the light guide sheet 25.

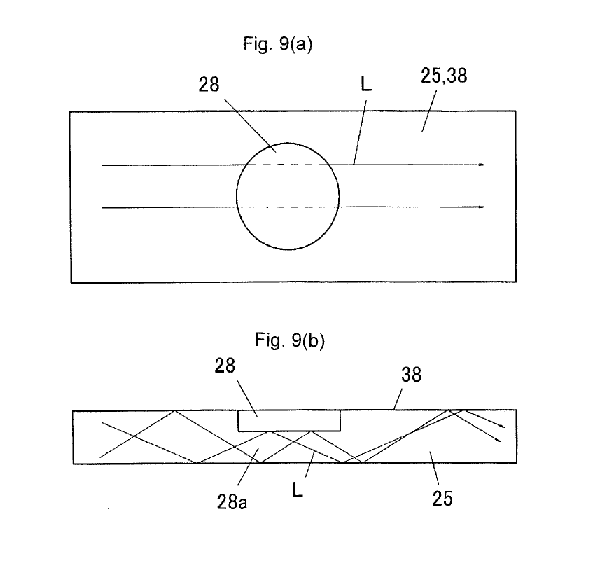

An annular groove 28 (recess) of a circular ring shape for alleviating the stress is arranged in the region facing the contact spring 23 in the front surface of the light guide sheet 25. The annular groove 28 is recessed on the front surface side of the light guide sheet 25, and the rear surface of the light guide sheet 25 is flat other than the light deflection pattern 33. The annular groove 28 has a constant width (i.e., not simple slit but has width) and a constant depth, and is a shallow groove of about a fraction of the thickness (total thickness of the material sheet) of the other portion of the light guide sheet 25, where the bottom surface of the annular groove 28 is a thin thickness portion 28a (see FIG. 9) where the thickness is partially reduced.

A technique (conventional technique) for forming the light deflection pattern 33 can be applied to a method for forming the annular groove 28 in the light guide sheet 25. If the depth of the annular groove 28 is about a fraction of the total thickness of the light guide sheet 25, the depth does not greatly change from the depth of the light deflection pattern 33, and hence the condition regarding molding does not greatly differ although the annular groove 28 and the light deflection pattern 33 have different shapes. Thus, the annular groove 28 can be created in the same step as forming the light deflection pattern 33 and also with substantially the same condition. Therefore, the difficulty does not become higher in creating the light guide sheet 25 even if the annular groove 28 is provided in the light guide sheet 25, and the rise in the manufacturing cost of the light guide sheet 25 can be suppressed to a minimum.

The switch with lighted key 41 (one unit portion) in the assembled state with the key top 34 added to the switch module with lighted key 21 is shown in FIG. 6. Each contact spring 23 is held at a predetermined position on the rear surface of the cover sheet 24 by adhering the vertex portion of the contact spring 23 to the adhesive layer 27. The cover sheet 24 is fixed to the front surface of the printed circuit board 22 by adhering the adhesive layer 27 to the front surface of the printed circuit board 22, so that the contact spring 23 is positioned and fixed on the annular contact section 26b so as to cover the fixed contact 26a. The light guide sheet 25 is placed over the cover sheet 24 with the positioning hole 32 coinciding with the positioning hole 31 of the printed circuit board 22, and fixed to the cover sheet 24 with a double-sided adhesive tape, glue, and the like. In the light guide sheet 25 positioned in this manner, the center of each annular groove 28 substantially coincides with the position of the vertex (center) of the contact spring 23. The light source 30 is mounted on the printed circuit board 22 so as to face the light incident portion 29 at the end face of the light guide sheet 25.

The key top 34 is arranged on the upper surface of the switch module with lighted key 21. The key top 34 has a plurality of keys 36 arrayed on the front surface of a flexible key sheet 35, and a pushing element 37 arranged on the rear surface of the key sheet 35 in correspondence to the lower surface of each key 36. The pushing element 37 is faced to the vertex of each contact spring 23 to be brought into contact with the front surface of the light guide sheet 25.

The switch module with lighted key 21 shown in FIG. 5 is an operation unit for a mobile telephone, where one cross-shaped key (not shown) is arranged at the position facing the fixed contact 26a and the annular contact section 26b in a region S indicated with a chain dashed line, and a key 36 is arranged as shown in FIG. 6 at the position facing the other fixed contact 26a and the annular contact section 26b.

[Illuminating Operation]

The key illuminating operation of the switch with lighted key 41 will now be described. As shown in FIG. 7, in the switch with lighted key 41, since the light source 30 is arranged facing the light incident portion 29 of the light guide sheet 25, when the light source 30 emits light, light L emitted from the light source 30 enters the light guide sheet 25 from the light incident portion 29. In this case, the light L entering the light guide sheet 25 spreads within the plane by the arcuate light incident portion 29. The light L that entered the light guide sheet 25 is guided by repeating reflection between the front surface and the rear surface of the light guide sheet 25. When the light L guided through the light guide sheet 25 enters the light deflection pattern 33, the light L totally reflected at the light deflection pattern 33 exits to the outside from the light exit surface 38. Since the light exit surface 38 is formed with microscopic diffusion patterns, the light L that exits from the light exit surface 38 is diffused by the diffusion pattern, so that the luminance distribution of the front surface of the light guide sheet 25 is uniformed. Thus, if the key top 34 is arrayed facing the light exit surface 38 of the light guide sheet 25, the key 36 can be uniformly illuminated from the rear surface side by the light that exits from the light guide sheet 25.

The light deflection pattern 33 has a greater distribution density the greater the distance from the light source 30, and hence the light amount that exits from the light exit surface 38 is uniformed at the entire light exit surface 38, and the luminance distribution is uniformed.

The cover sheet 24 facing the rear surface of the light guide sheet 25 has high reflectance and serves as a reflection sheet, and thus the light leaked from the rear surface of the light guide sheet 25 is reflected at the cover sheet 24 and re-enters the light guide sheet 25. Thus, the loss by the light leaked from the rear surface of the light guide sheet 25 can be reduced and the usage efficiency of the light can be enhanced.

[Switch Operation]

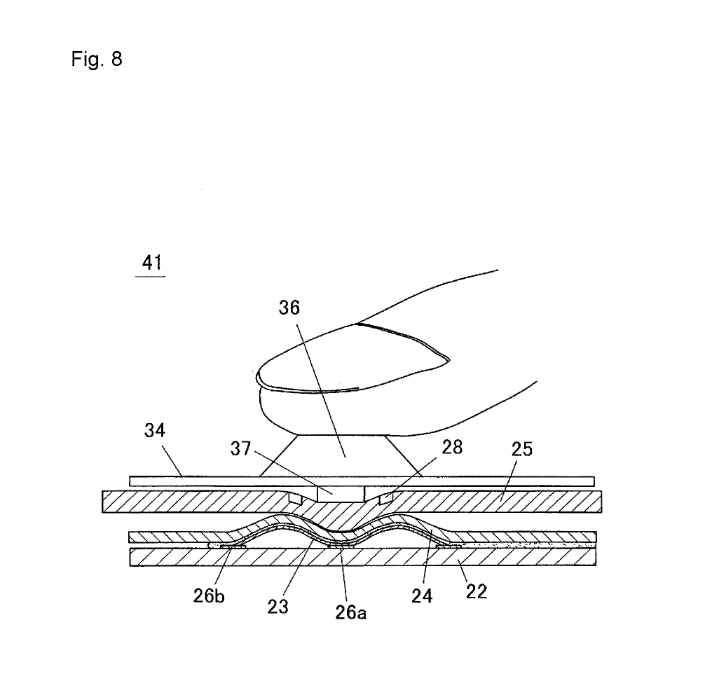

The operation when the key 36 is pushed will now be described. As shown in FIG. 8, when the key 36 is pushed, the pushing element 37 pushes the contact spring 23 through the light guide sheet 25 and the cover sheet 24. The pushed contact spring 23 is elastically deformed and the central part is squashed, so that the contact spring 23 contacts the fixed contact 26a and the fixed contact 26a and the annular contact section 26b are electrically conducted to thereby turning ON the switch.

In this case, the elastic rebound stress is generated at the light guide sheet 25 since the light guide sheet 25 pushed by the pushing element 37 elastically bends. However, the elastic rebound stress of the light guide sheet 25 becomes small and the lowering of the click feeling when pushing the key 36 is suppressed since the circular ring shaped annular groove 28 is provided in the light guide sheet 25. In other words, the light guide sheet 25 is easily deformed since the light guide sheet 25 partially has a thin thickness portion at the portion provided with the annular groove 28 of the light guide sheet 25, and the elastic rebound stress of the light guide sheet 25 is reduced (elastic rebound stress of the sheet is inversely proportional to the cube of the sheet thickness (Mole's theory). Accordingly, a force is easily transmitted from the key 36 to the contact spring 23 and the click feeling can be improved.

The click feeling can be improved (see Table 1) by reducing the thickness of the entire light guide sheet, but the thicknesses of the light incident portion and the light guide sheet themselves become thin if the thickness of the entire light guide sheet is reduced, and hence the light emission amount for the backlight of the light guide sheet is reduced and the optical performance of the light guide sheet is lowered. In the switch with lighted key 41 of the above embodiment, on the other hand, the sheet thickness does not need to be reduced compared to the conventionally used light guide sheet since the thickness of the light guide sheet 25 is partially reduced by the annular groove 28, and both the optical performance of the light guide sheet 25 and the operation feeling of the key 36 can be satisfied.

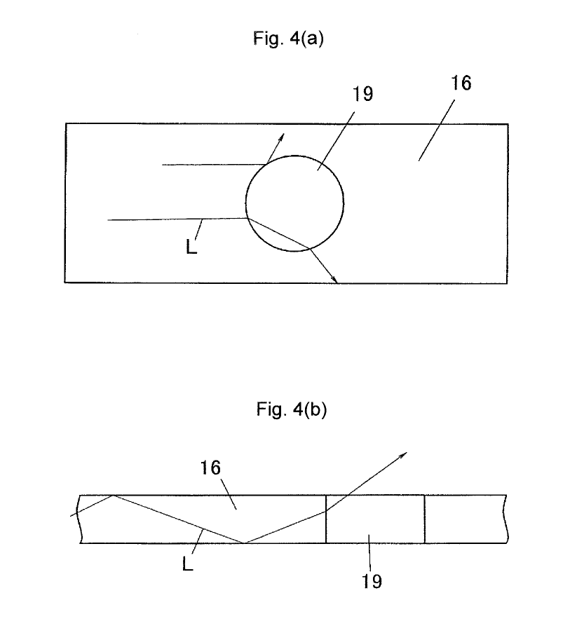

The click feeling also can be improved by providing a through-hole in the light guide sheet, but the guiding of light is blocked by the through-hole (see FIG. 4) if the through-hole is formed in the light guide sheet. Hence, the optical performance of the light guide sheet degrades such that the luminance may be lowered at the back of the through-hole or the bright point/bright line may occur. In the switch with lighted key 41 of the above embodiment, on the other hand, the annular groove 28 does not penetrate the light guide sheet 25, and the thin thickness portion 28a is ensured below the annular groove 28. Hence, the light that reached the annular groove 28 can be guided and passed through the thin thickness portion 28a below the annular groove 28, as shown in FIGS. 9(a) and 9(b), so that the luminance is less likely to be lowered at the back of the annular groove 28, the bright point and the bright line are less likely to occur, and the lowering of the optical performance of the light guide sheet 25 can be reduced. Therefore, the loss of the light reaching the annular groove 28 can be greatly suppressed by selecting a most suitable material for satisfying the optical performance for the backlight of the light guide sheet 25, and then setting the groove depth of the annular groove 28 to a depth of about a fraction of the total thickness of the light guide sheet 25, and suitably designing the groove cross-sectional shape, the dimension, the direction, and the like of the annular groove 28, as will be hereinafter described. The high optical performance for the backlight of the light guide sheet 25 can thus be maintained.

Furthermore, the material of the light guide sheet is restricted in the method of improving the click feeling by using the light guide sheet of high flexibility as in Patent Document 1, but a material having high optical performance such as polycarbonate resin, acrylic resin, polyethylene terephthalate (PET), and the like conventionally used for the light guide sheet can be used since the material of the light guide sheet 25 is less likely to be restricted in the above embodiment.

According to one or more embodiments of the present invention, the click feeling of the switch with lighted key 41 can be improved by arranging the annular groove 28, where the click feeling can be further improved by suitably designing particularly the position and the groove width of the annular groove 28 to alleviate the elastic rebound stress. This will be described below.

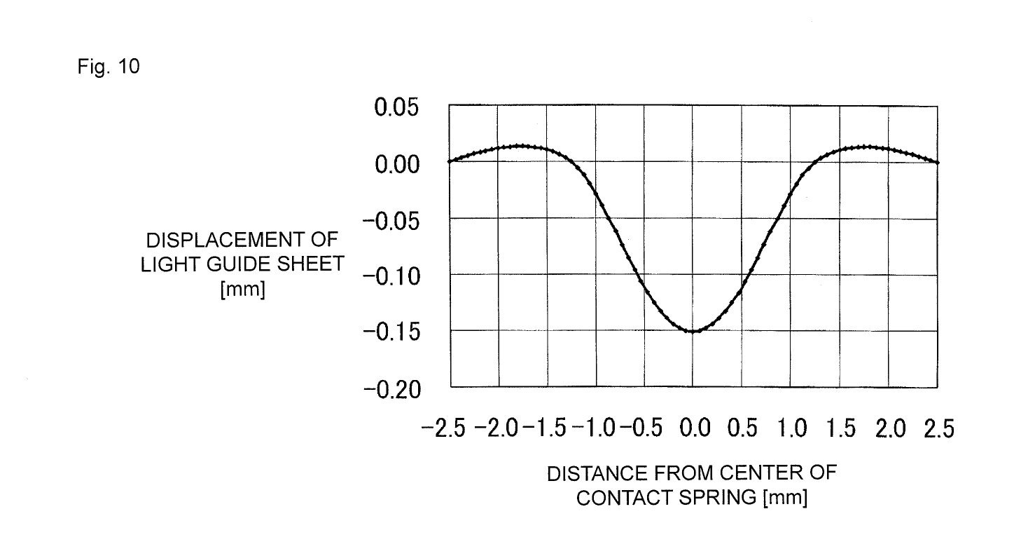

FIG. 10 shows the result of simulating the displacement of the light guide sheet when the key 36 is pushed as in FIG. 8. The sample used in the simulation has a diameter of the contact spring 34 of 4 mm (contact spring having a diameter of 4 mm is used in mobile telephones), the light guide sheet is not provided with the annular groove 28 and has a sheet thickness of 125 μm, and the diameter of the pushing element 37 is 1.5 mm. The horizontal axis of FIG. 10 shows the distance measured from the center of the contact spring 23 when seen from a direction perpendicular to the printed circuit board 22. The vertical axis of FIG. 10 shows the displacement amount of the light guide sheet, where the positive value indicates the displacement amount to the upper side (front surface side) and the negative value indicates the displacement amount to the lower side (rear surface side). Thus, the curve in FIG. 10 shows the cross-sectional shape of the light guide sheet deformed when the key 36 is pushed. The change in shape of the light guide sheet follows the change in shape of the contact spring 23, and occurs from the bend having the center of the contact spring 23 and the peak point thereof as the supporting point.

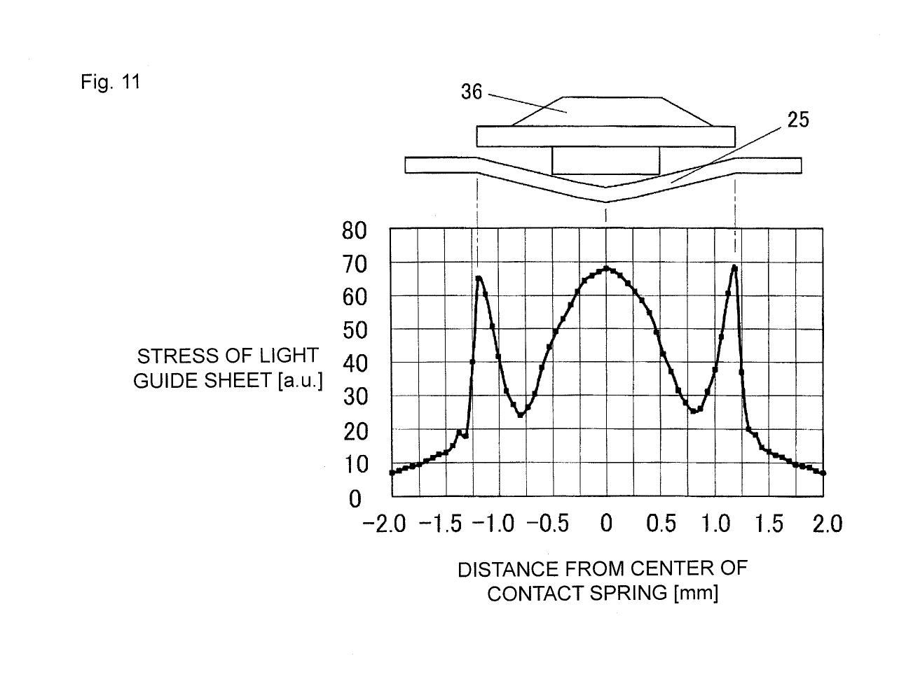

FIG. 11 similarly shows the magnitude of the elastic rebound stress generated at the rear surface of the light guide sheet (25) when the key 36 is pushed in. The sample used in this simulation also has a diameter of the contact spring 23 of 4 mm, a light guide sheet of a sheet thickness of 125 μm where the annular groove 28 is not arranged, and a diameter of the pushing element 37 of 1.5 mm. The horizontal axis of FIG. 11 shows the distance measured from the center of the contact spring 23 when seen from the direction perpendicular to the printed circuit board 22. The vertical axis of FIG. 11 shows the elastic rebound stress at the rear surface of the light guide sheet 25 in an arbitrary unit (a.u.).

Comparing FIG. 10 and FIG. 11, it can be seen that the elastic rebound stress is maximum at the inflection point of the deformed light guide sheet and the position corresponding to the center of the contact spring 23. The area where the elastic rebound stress is maximum is the point corresponding to the center of the contact spring 23 and the area of about 1.2 mm from the center. In other words, the area where the elastic rebound stress is maximum is the point corresponding to the center of the contact spring 23, and the area of about 0.6 times (=1.2/2) of the radius of the contact spring 23 from the center of the contact spring 23. Thus, if the thickness of the light guide sheet 25 is reduced by arranging the annular groove 28 in the region where the elastic rebound stress is maximum, the elastic rebound stress generated at the light guide sheet 25 can be reduced, whereby satisfactory click feeling of the switch with lighted key 41 can be obtained. The annular groove 28 according to one or more embodiments of the present invention has an inner diameter (diameter) of greater than or equal to ½ of the diameter of the contact spring 23 and an outer diameter of smaller than or equal to the diameter of the contact spring 23. As described below, the width of the annular groove 28 according to one or more embodiments of the present invention is greater than or equal to 200 μm, and thus the inner diameter of the annular groove 28 is desirably greater than or equal to 0.5 times and smaller than or equal to 0.6 times the diameter of the contact spring 23.

The relationship between the groove width of the annular groove 28 and the degree of improvement of the click feeling was reviewed by simulation. At the same time, the degrees of improvement of the click rate when the annular groove 28 is provided on the front surface of the light guide sheet 25 and when the annular groove 28 is provided on the rear surface were compared.

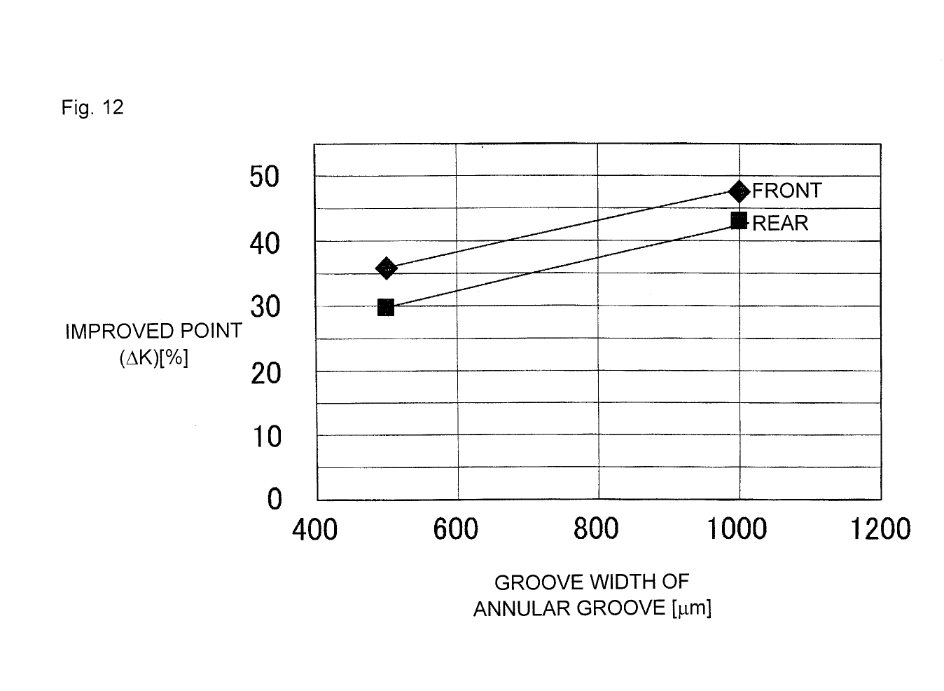

FIG. 12 is a view showing the relationship between the groove width of the annular groove 28 provided on the front surface or the rear surface of the light guide sheet 25, and the improvement point of the click rate. An improvement point ΔK shown on the vertical axis of FIG. 12 is the degree of improvement in the click rate as a result of providing the annular groove 28, and is defined as:

ΔK=K2−K1[%]

where K1[%] is the click rate when the annular groove 28 is not provided on the light guide sheet 25, and K2[%] is the click rate when the annular groove 28 is provided on the light guide sheet 25.

The sample used in the simulation is one in which the annular groove 28 of a square cross-section having an inner diameter (diameter) of 1.5 μm and a depth of 40 μm is provided in the polycarbonate light guide sheet 25 having a sheet thickness of 100 μm. The contact spring 23 has a diameter of 4 mm.

As is apparent from FIG. 12, the improvement point of the click rate becomes higher the wider the groove width of the annular groove 28 in the appropriate range. In the simulation range of FIG. 12, the groove width according to one or more embodiments of the present invention is 1000 μm, and the groove cross-sectional shape of the annular groove 28 is considerably flat. Furthermore, the improvement point becomes higher and the effect in improving the click rate is higher if the annular groove 28 is provided on the front surface rather than on the rear surface of the light guide sheet 25.

(Variant of First Embodiment)

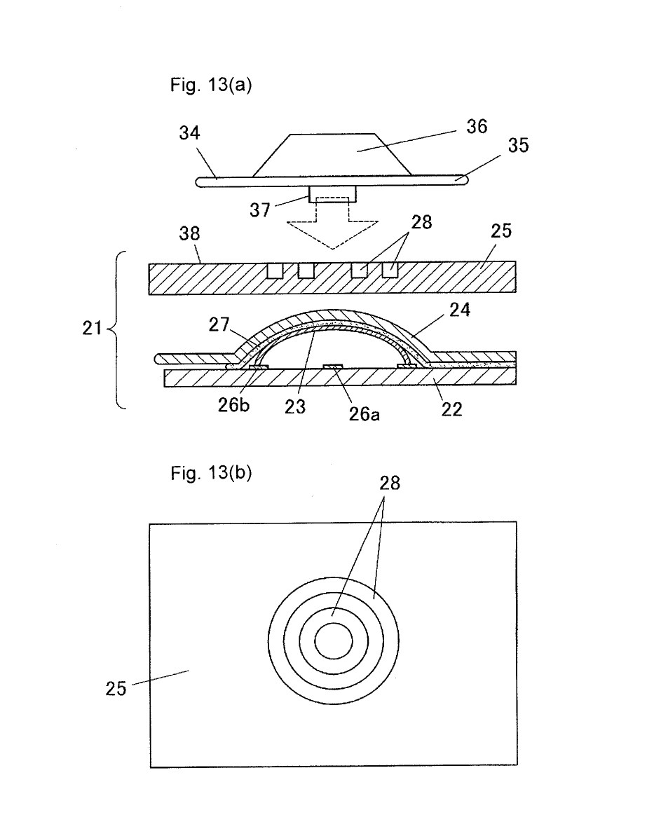

FIG. 13(a) is a schematic cross-sectional view showing a switch with lighted key (one unit portion) according to a variant of the first embodiment, and FIG. 13(b) is a plan view showing the light guide sheet 25 thereof. In this variant, a plurality of annular grooves 28 are concentrically arranged. Since the plurality of annular groove 28 are arranged, the elastic rebound stress of the light guide sheet 25 can be further reduced and the click rate can be further improved.

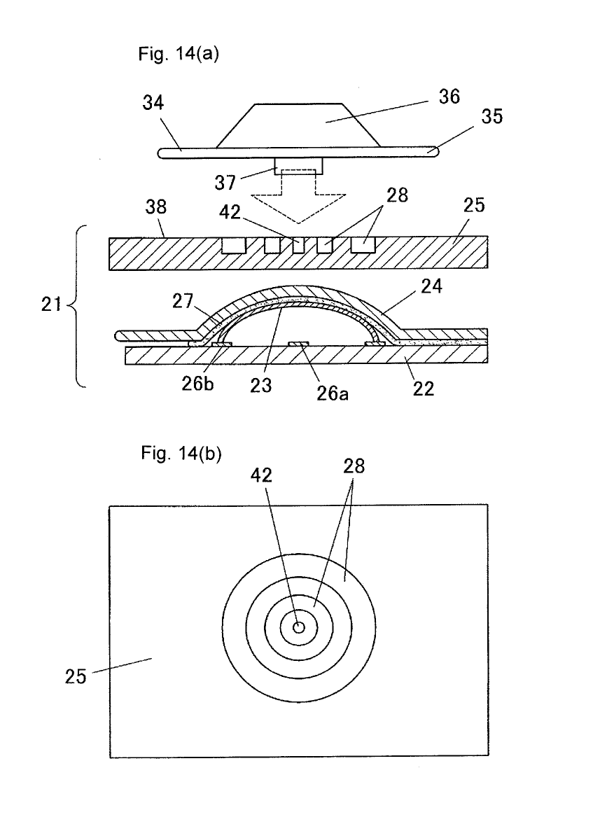

FIG. 14(a) is a schematic cross-sectional view showing a switch with lighted key (one unit portion) according to another variant of the first embodiment, and FIG. 14(b) is a plan view showing the light guide sheet 25 thereof. In this variant, a circular recess 42 is formed at the center of the annular groove 28. As shown in FIG. 11, since the elastic rebound stress of the light guide sheet 25 is maximum at the area facing to the center of the contact spring 23, the elastic rebound stress at the center portion can be reduced by arranging the recess 42 at the region facing the center of the contact spring 23 as in the present variant and the click rate can be further improved.

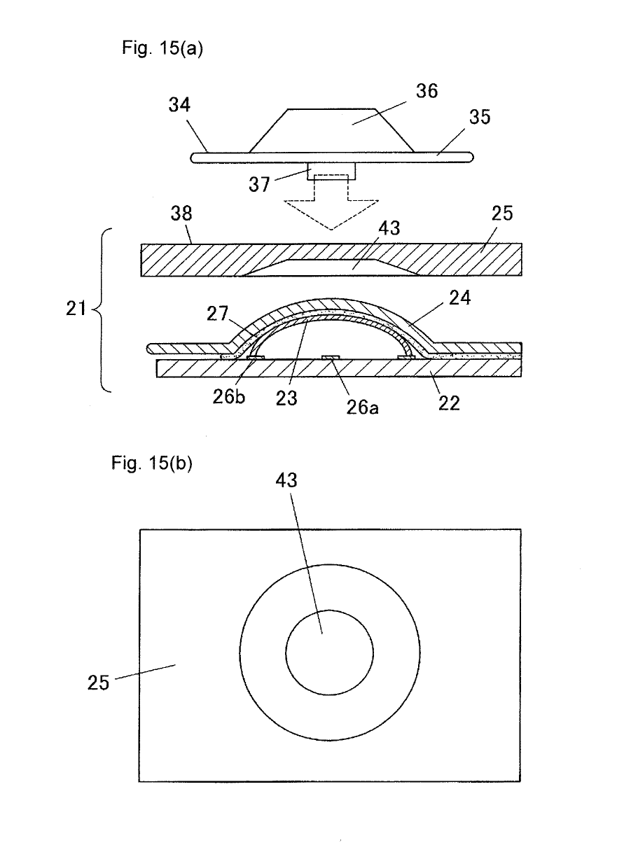

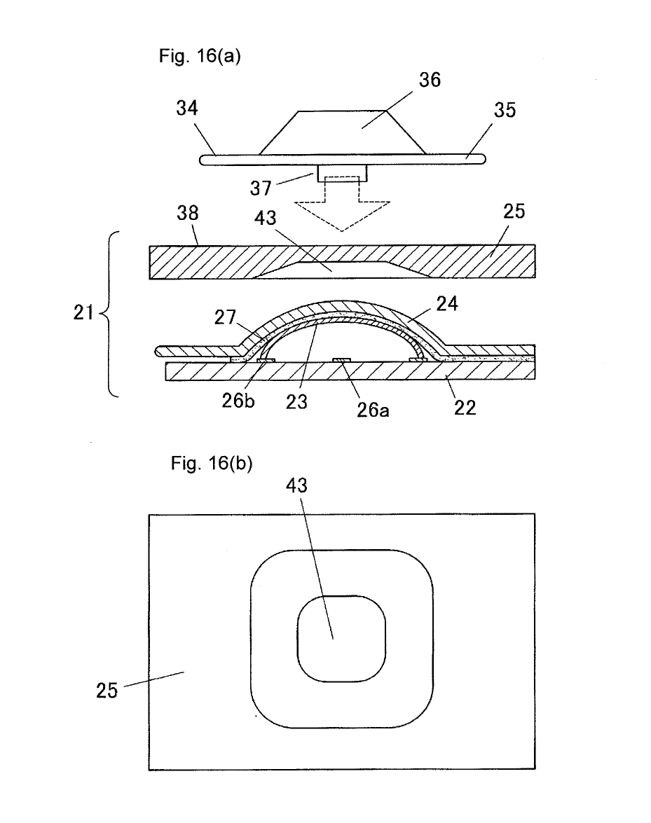

FIG. 15(a) is a schematic cross-sectional view showing a switch with lighted key according to still another variant of the first embodiment, and FIG. 15(b) is a rear view showing the light guide sheet 25 thereof. In this variant, a circular plate shaped recess 43 is arranged over substantially the entire region facing the contact spring 23 at the rear surface of the light guide sheet 25. According to such a variant, the thickness the light guide sheet 25 can be reduced in the entire region corresponding to the contact spring 23 and the elastic rebound stress can be reduced, so that the click rate can be improved. The recess 43 arranged at the rear surface of the light guide sheet 25 may be a shallow cylindrical shape or may be a square plate shape in which the corner is formed with a curved surface, as shown in FIGS. 16(a) and 16(b).

The groove cross-sectional shape of the annular groove 28 of the first embodiment is not limited to a square, and may be an arbitrary shape such as a semicircular shape, an arcuate shape, a U-shape, a V-shape (triangular shape), or a trapezoidal shape.

### Second Embodiment

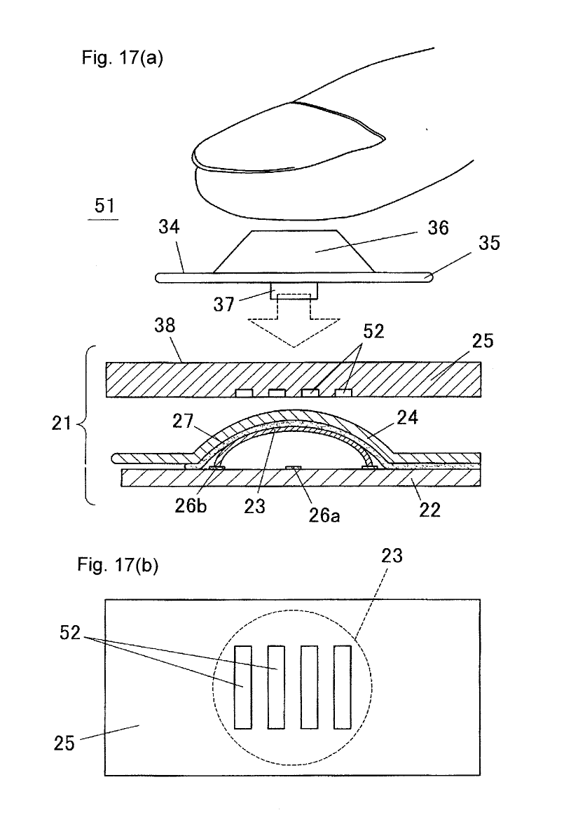

FIG. 17(a) is a schematic cross-sectional view showing a switch with lighted key 51 (one unit portion) according to a second embodiment of the present invention, and FIG. 17(b) is a rear view of the light guide sheet 25 used in the switch with lighted key 51. In the switch with lighted key 51, a linear recessed groove 52 (recess) having a constant width is formed in the region facing the contact spring 23 at the rear surface of the light guide sheet 25. The switch with lighted key 51 according to the second embodiment has a structure similar to the switch with lighted key 41 of the first embodiment other than the structure of the recess, and thus the description on the structure other than of the recess 52 will be omitted.

Four recessed grooves 52 having a square groove cross-section are shown in FIG. 17, but the number of the recessed groove 52 may be one to three, or may be five or more. The groove cross-sectional shape of the recessed groove 52 is not limited to a square, and may have an arbitrary shape such as semicircular shape, arcuate shape, U-shape, V-shape (triangular shape), or trapezoidal shape. In the case of the recessed groove 52 with square cross-section, an R surface or an inclined surface (C surface) may be arranged at the inner corner.

The recessed groove 52 is arranged line symmetric with respect to a virtual line passing the point corresponding to the center of the contact spring 23 or is arranged point symmetric with respect to a point corresponding to the center of the contact spring 23. The recessed groove 52 is desirably arranged such that the area the recessed groove 52 overlaps the region where the elastic restoration stress of the light guide sheet 25 becomes a local maximum value is as large as possible when seen from a direction perpendicular to the printed circuit board 22.

In the case of such a recessed groove 52 as well, effects similar to the first embodiment can be obtained by reducing the elastic rebound stress of the light guide sheet 25 by the recessed groove 52 to improve the click feeling, and the like. Furthermore, since the recessed groove 52 is linear, the area when seen from the light source 30 side can be reduced compared to the circular ring shaped annular groove 28 of the first embodiment, and the light L from the light source 30 is unlikely to be blocked by the recessed groove 52. The back of the recessed groove 52 is thus unlikely to become dark, and the optical performance of the light guide sheet 25 becomes more satisfactory.

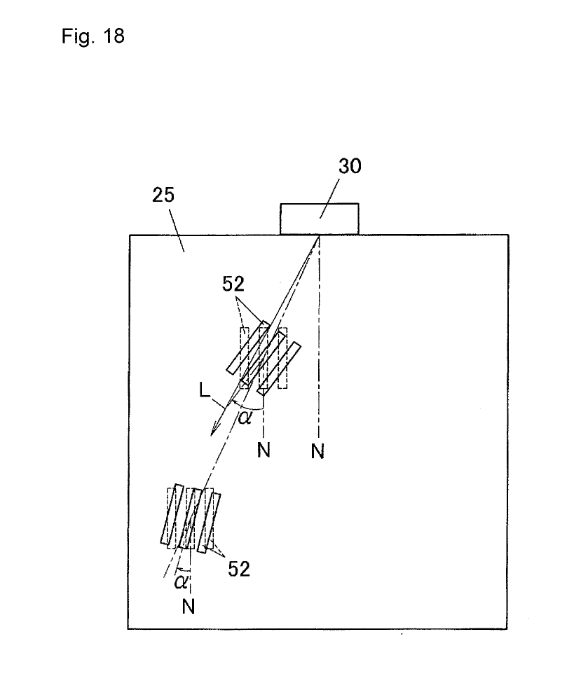

Furthermore, in the switch with lighted key 51 of the second embodiment, the recessed groove 52 is arranged so as to tilt the longitudinal direction of each recessed groove 52 from the direction parallel to the front surface direction N of the light source 30 to the direction connecting the position of the recessed groove 52 and the light source 30, as shown in FIG. 18. In FIG. 18, the angle at which the recessed groove 52 is tilted from the front surface direction N is indicated as α. If the recessed groove 52 is arranged tilted in this manner, the light L from the light source 30 is less likely to be blocked by the recessed groove 52 compared to the recessed groove 52 (longitudinal direction is parallel to front surface direction N) shown with a broken line in FIG. 18, whereby the back of the recessed groove 52 is more unlikely to become dark, and the optical performance of the light guide sheet 25 further improves.

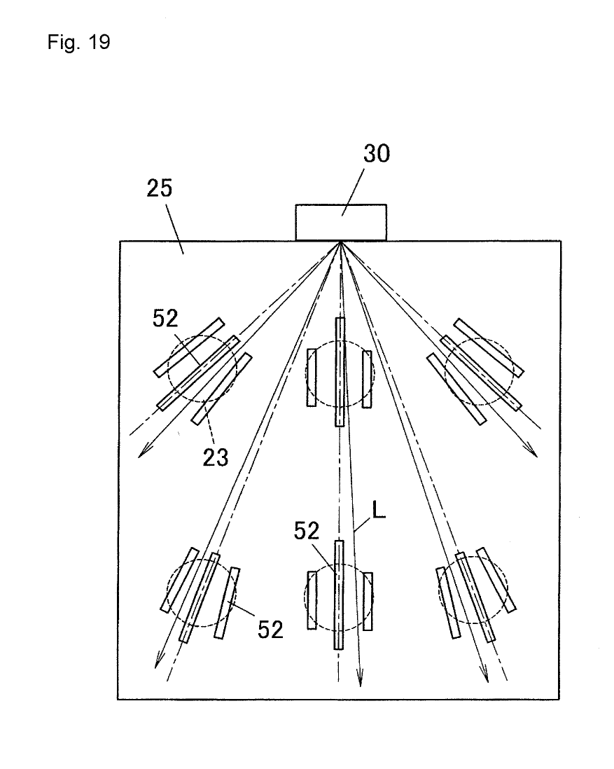

According to one or more embodiments of the present invention, the elastic rebound stress of the light guide sheet 25 becomes small in the region corresponding to the contact spring 23, and at the same time, the light L from the light source 30 is very unlikely to be blocked by the recessed groove 52 by having the longitudinal direction of each recessed groove 52 substantially parallel to the direction connecting the position of the recessed groove 52 and the light source 30, and hence the optical performance of the switch with lighted key 51 becomes satisfactory, as shown in FIG. 19. Furthermore, since the light L is less likely to be totally reflected at the side surface of the recessed groove 52, the light totally reflected at the side surface is less likely to leak out and cause a bright line.

A method of having the groove cross-sectional shape of the recessed groove 52 to a triangular shape, a trapezoidal shape, and the like and inclining the side surface is also effective as a method for preventing the light from leaking at the side surface of the recessed groove 52.

The recessed grooves 52 arranged in a region facing one contact spring 23 may be parallel as shown in FIG. 18, or may be non-parallel as shown in FIG. 19. Each recessed groove 52 may have the same length as shown in FIG. 18, or may have a different length from each other as shown in FIG. 19.

The recessed groove 52 according to one or more embodiments of the present invention will now be described. As the elastic rebound stress of the light guide sheet 25 is inversely proportional to the cube of the sheet thickness of the light guide sheet 25, the elastic rebound stress of the light guide sheet 25 can be alleviated by reducing the effective sheet thickness of the light guide sheet 25 in the region facing the contact spring 23 with the length, the width, the cross-sectional shape, the number, and the like of the recessed groove 52 as parameters.

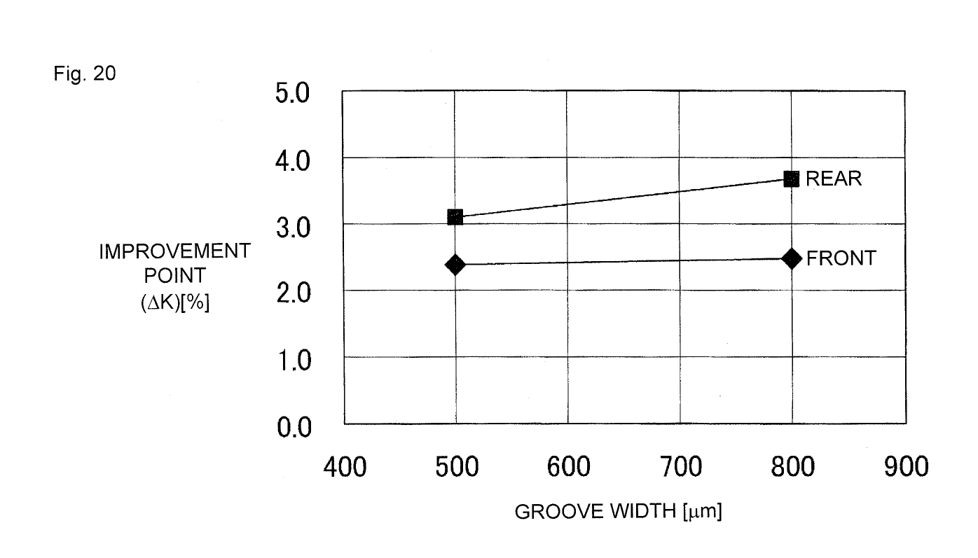

First, FIG. 20 shows a result of actually measuring the relationship of the groove width of the recessed groove 52 arranged on the front surface or the rear surface of the light guide sheet 25, and the improvement point AK of the click rate. The sample used in the actual measurement has one recessed groove 52, which has a square cross-sectional shape of a length of 3 mm and a depth of 40 μm, arranged in the light guide sheet 25 made of polycarbonate having a sheet thickness of 125 μm. The contact spring 23 has a diameter of 4 mm.

As is apparent from FIG. 20, the improvement point ΔK of the click rate becomes higher the wider the groove width of the annular groove 28 in the appropriate range. In the actual measurement range of FIG. 20 according to one or more embodiments of the present invention, the groove width is 800 μm, where the groove cross-sectional shape of the recessed groove 52 is considerably flat and shallow. The improvement point AK becomes higher if the recessed groove 52 is provided on the rear surface rather than on the front surface, and thus has higher effect in improving the click rate.

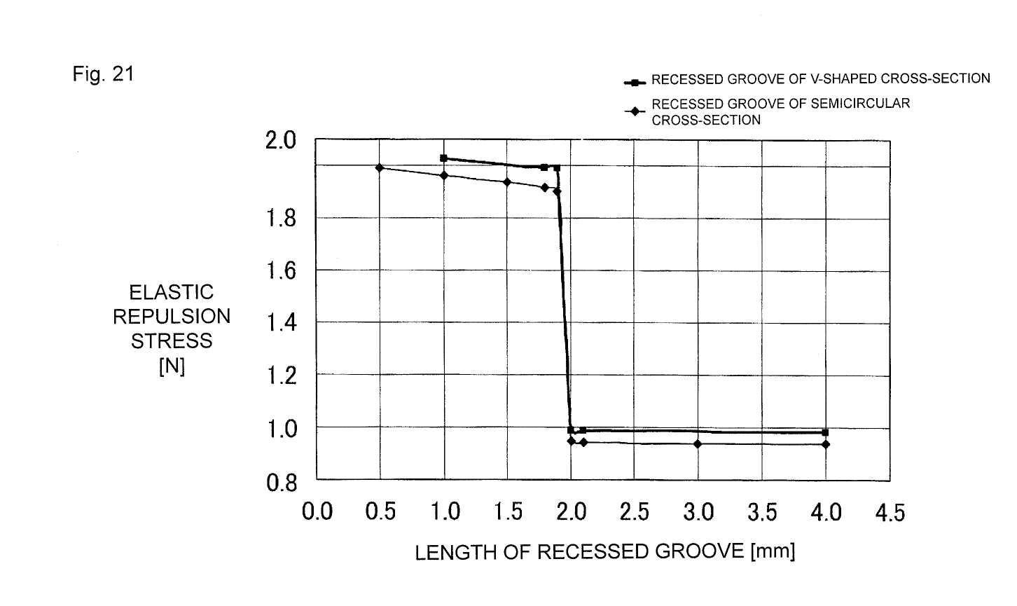

FIG. 21 shows a result of actually measuring the relationship of the length of the recessed groove 52 and the elastic repulsion stress in the light guide sheet 25 provided with the recessed groove 52 having a V-shaped cross section and in the light guide sheet 25 provided with the recessed groove 52 having a semicircular cross-section. The sample used in the actual measurement has one recessed groove 52, which has a width of 200 μm and a depth of 40 μm, arranged in the light guide sheet 25 made of polycarbonate having a sheet thickness of 125 μm. The contact spring 23 has a diameter of 4 mm.

As is apparent from FIG. 21, the elastic rebound stress rapidly changes when the length of the recessed groove 52 is 2 mm (i.e., ½ of the diameter of the contact spring 23), and the elastic repulsion stress can be reduced when the length of the recessed groove 52 is greater than or equal to 2 mm (i.e., greater than or equal to ½ of the diameter of the contact spring 23) regardless of the cross-sectional shape of the recessed groove 52. Although not shown in FIG. 21, similar result is obtained for the recessed groove 52 having a square groove cross-section. Therefore, the elastic repulsion stress can be reduced and a satisfactory click rate can be obtained by having the length of the recessed groove 52 to greater than or equal to ½ of the diameter of the contact spring 23, regardless of the cross-sectional shape of the recessed groove 52.

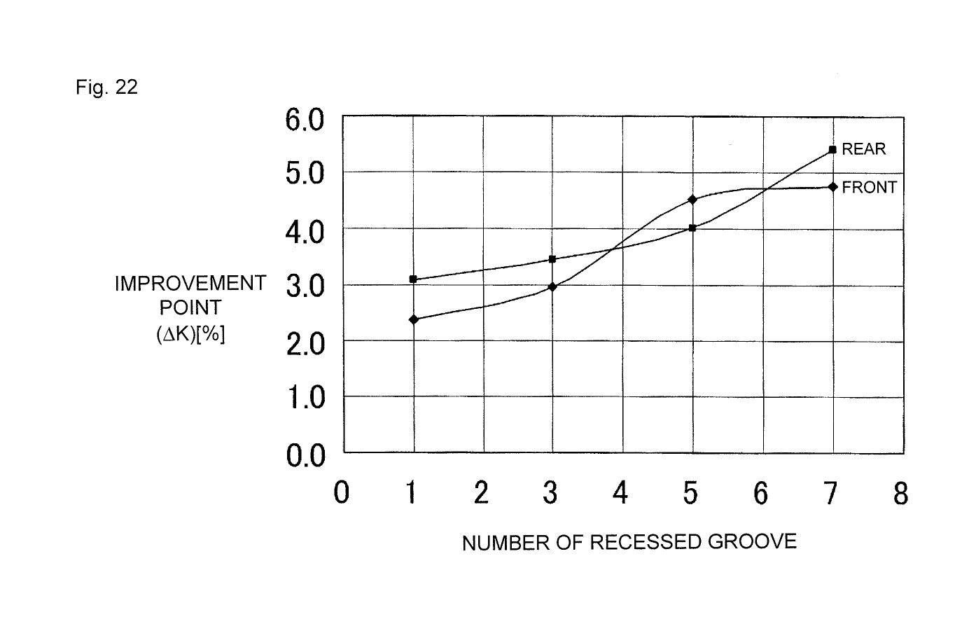

FIG. 22 shows a result of actually measuring the relationship of the number of recessed groove 52 arranged on the front surface or the rear surface of the light guide sheet 25, and the improvement point ΔK of the click rate. The sample used in the actual measurement has the recessed groove 52, which has a square cross-sectional shape of a length of 3 mm, width of 500 μm, and a depth of 40 μm, arranged in the light guide sheet 25 made of polycarbonate having a sheet thickness of 125 μm. The contact spring 23 has a diameter of 4 mm. The recessed grooves 52 are arranged at equal intervals within the range of 4 mm (width of contact spring 23) so as to be symmetrical with respect to the line passing the point corresponding to the center of the contact spring 23.

According to FIG. 22, the improvement point ΔK becomes greater the greater the number of recessed groove 52, and the click rate improves regardless of the front and the rear of the light guide sheet 25.

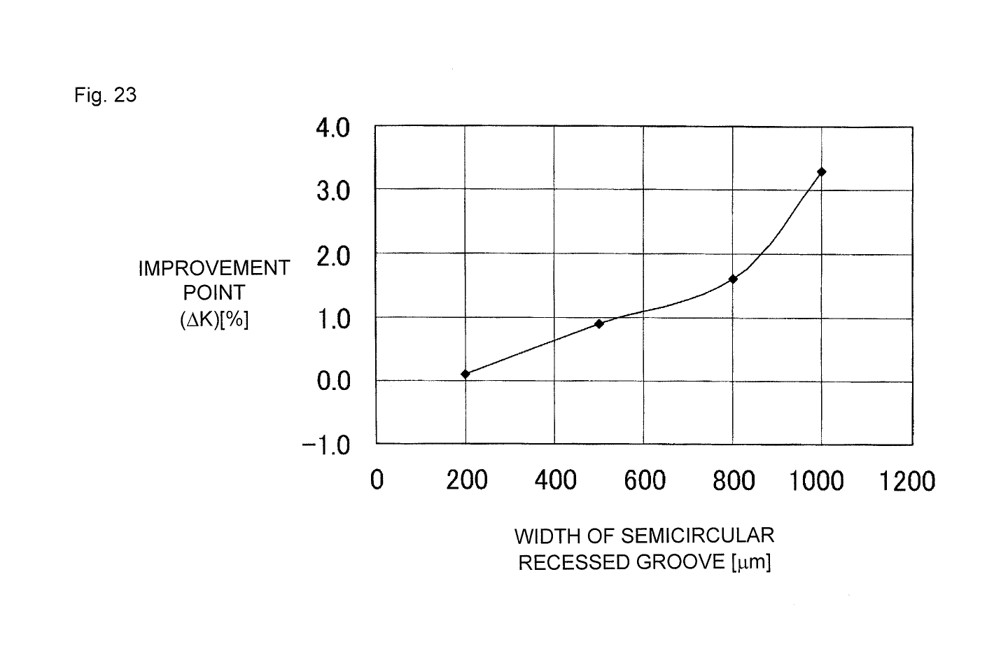

FIG. 23 shows a result of actually measuring the relationship of the width of the recessed groove 52 having a semicircular cross-section, and the improvement point ΔK of the click rate. The sample used in the actual measurement has one recessed groove 52, which has a semicircular cross-sectional shape of a length of 3 mm and a depth of 40 μm, arranged in the light guide sheet 25 made of polycarbonate having a sheet thickness of 125 μm. The contact spring 23 has a diameter of 4 mm.

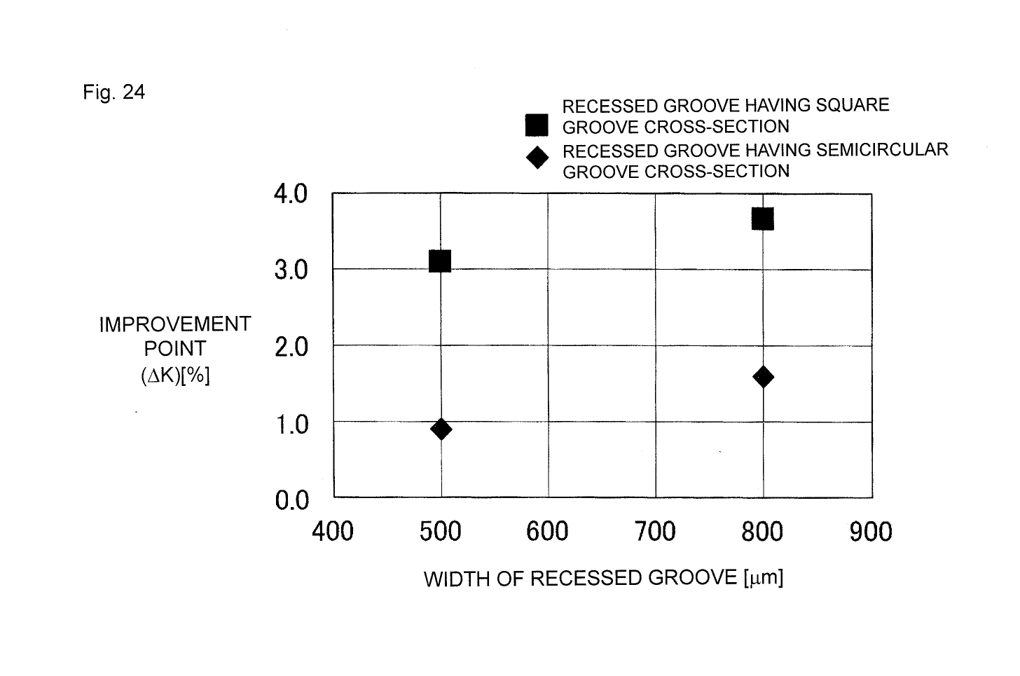

According to FIG. 23, the click rate becomes greater if the width of the recessed groove 52 is greater than 200 μm. FIG. 24 compares the improvement points ΔK of the recessed groove 52 having a square cross-section and the recessed groove 52 having a semicircular cross-section, where the improvement point ΔK is greater in the recessed groove 52 of square cross-section than in the recessed groove 52 of semicircular cross-section if the width of the recessed groove 52 is the same. The improvement point ΔK is the worst in the recessed groove 52 of semicircular cross-section compared with other cross-sectional shapes. Therefore, the effect of improving the click rate is obtained by making the width of the recessed groove 52 greater than 200 μm regardless of the cross-sectional shape of the recessed groove 52. This result also applies not only on the recessed groove 52 but also to the annular groove 28, where the effect of improving the click rate can be enhanced by also having the groove width of the annular groove 28 to greater than or equal to 200 μm. The cross-sectional shape of the recessed groove 52 according to one or more embodiments of the present invention is a square or a shape close to a square.

(Variant of Second Embodiment)

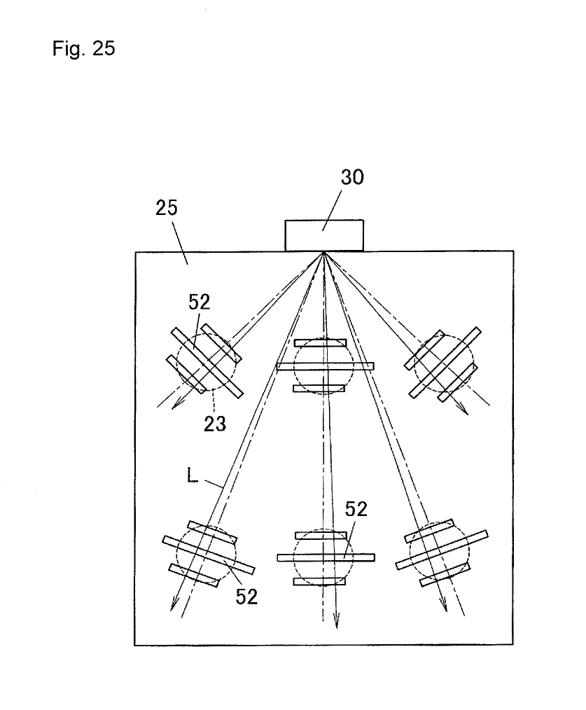

FIG. 25 is a rear view showing a variant of the second embodiment. In this variant, the longitudinal direction of the recessed groove 52 is arranged so as to be substantially orthogonal to the direction connecting the relevant position and the light source 30. The effect of improving the click rate is the same as the second embodiment even if the recessed groove 52 is arranged in such a direction. The probability of blocking the light L from the light source 30 with the recessed groove 52 becomes higher, but the light L passes the recessed groove 52 and can also reach the rear side since the recessed groove 52 is in a linear form.

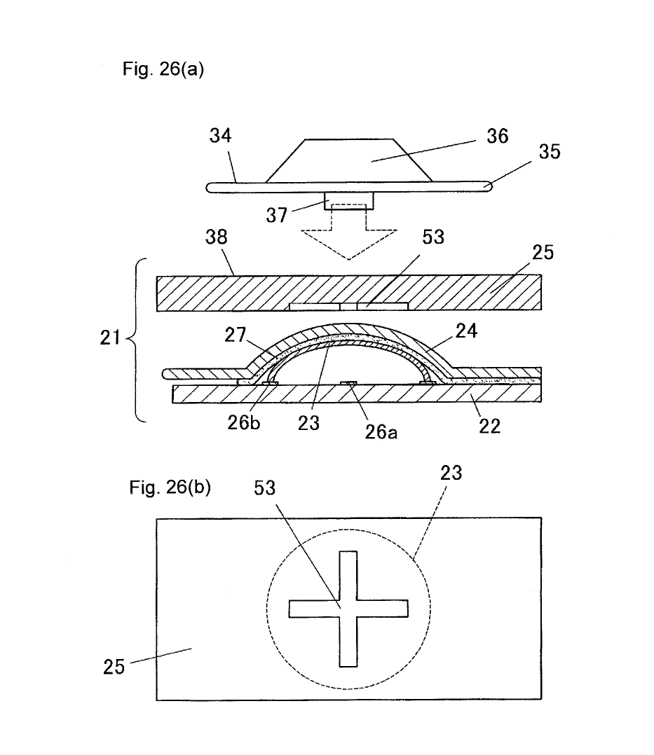

FIGS. 26(a) and 26(b) are a schematic cross-sectional view showing a switch with lighted key (one unit portion) according to another variant of the second embodiment, and a rear view of the light guide sheet. In this variant, a recessed groove 53 having a cross shape by intersecting the linear recessed grooves is arranged.

### Third Embodiment

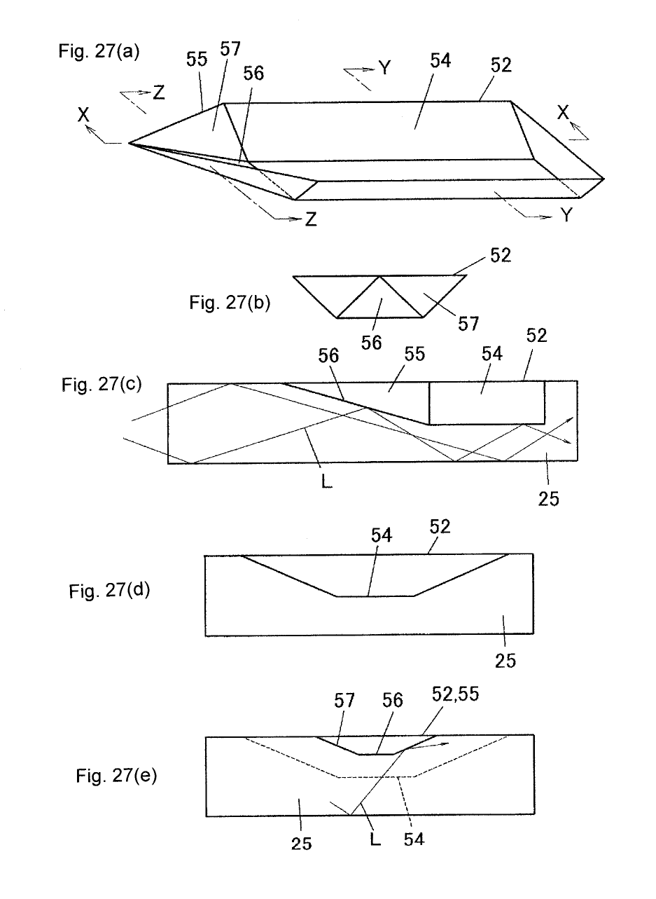

FIGS. 27(a) and 27(b) are a perspective view and a front view showing a shape of the recessed groove 52 in a switch with lighted key according to a third embodiment of the present invention. FIGS. 27(c), 27(d), and 27(e) are a cross-sectional view taken along line X-X, a cross-sectional view taken along line Y-Y, and a cross-sectional view taken along line Z-Z of FIG. 27(a). The structure and the effects of the switch with lighted key of the third embodiment are similar to the switch with lighted key 51 of the second embodiment except for the shape of the recessed groove 52, and thus the description other than of the recessed groove 52 will be omitted for the switch with lighted key of the third embodiment.

Each recessed groove 52 in the third embodiment has a ship bottom shape as a whole, where a first groove portion 54 having a reversed trapezoidal cross-section as shown in FIG. 27(d) and a second groove portion 55 (groove portion for optical path conversion) configured by an inclined surface as shown in FIGS. 27(a), 27(b) are formed continuously. The first groove portion 54 is a recess for improving the click rate, and the second groove portion 55 is a groove portion for optical path conversion. The second groove portion 55 is configured by an inclined bottom surface 56 inclined so as to gradually become shallower the farther away from the first groove portion 54 as shown in FIG. 27(c), and an inclined side portion 57 arranged on both sides of the inclined bottom surface 56 and inclined so as to gradually become shallower the farther away from the inclined bottom surface 56 as shown in FIG. 27(e).

The recessed groove 52 is arranged so that the second groove portion 55 side is close to the light source 30 and the first groove portion 54 side is distant from the light source 30. Thus, the light L incoming from a direction substantially perpendicular to the end face of the first groove portion 54 enters the second groove portion 55. The light L that entered the inclined bottom surface 56 and the inclined side portion 57 of the second groove portion 55 is totally reflected at the inclined bottom surface 56 and the inclined side portion 57 so that the direction of the light L is bent, as shown in FIGS. 27(c) and 27(e), and hence the light is less likely to leak from the end face of the first groove portion 54 to outside the light guide sheet 25. Therefore, the light is prevented from leaking from the recessed groove 52 and from causing a bright point or a bright line. The usage efficiency of the light from the light source 30 can be enhanced and the luminance at the light exit surface 38 of the light guide sheet 25 can be enhanced.

(Variant of Third Embodiment)

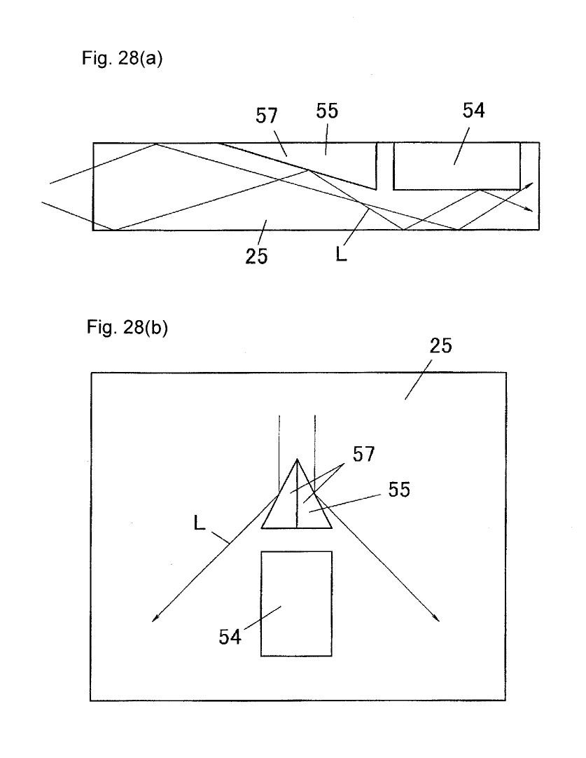

FIGS. 28(a) and 28(b) show a shape of the recessed groove 52 according to a variant of the third embodiment. In this variant, the first groove portion 54 and the second groove portion 55 are separately formed, and the second groove portion 55 having the inclined side portion 57 is arranged on the side close to the light source 30 than the first groove portion 54. Therefore, the light L incoming from the direction substantially perpendicular to the end face of the first groove portion 54 can be reflected by the inclined side portion 57 to bend the direction of the light L, and the light can be prevented from leaking from the end face of the first groove portion 54 to the outside. In the recessed groove 52 shown in FIG. 27, it is difficult to form the recessed groove 52 in the light guide sheet 25 since the first groove portion 54 and the second groove portion 55 are continuously formed. In the recessed groove 52 shown in FIG. 28, on the other hand, the first groove portion 54 and the second groove portion 55 are separated to form separate recesses. Thus, the first groove portion 54 and the second groove portion 55 can be molded as separate patterns, and the recessed groove 52 can be easily formed. Although the inclined bottom surface 56 is not arranged in FIG. 28, the inclined bottom surface 56 may be arranged in the variant of FIG. 28, and the inclined bottom surface 56 may be omitted in the third embodiment of FIG. 27.

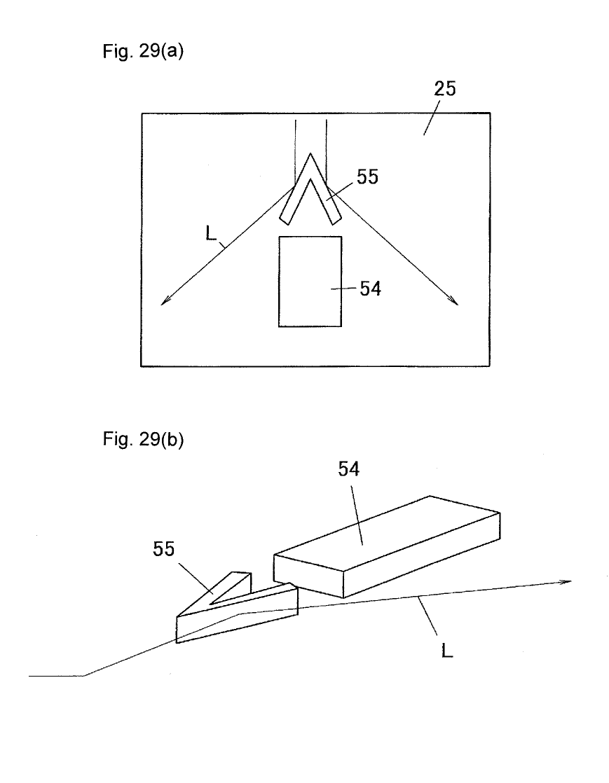

FIGS. 29(a) and 29(b) show a shape of the recessed groove according to another variant of a third embodiment. In this variant as well, the first groove portion 54 and the second groove portion 55 are separated to form separate recesses, so that the recessed groove 52 is easily formed. The first groove portion 54 is a groove having a square cross-sectional shape, and the second groove portion 55 is a groove having a V-shape in plan view. The light L from the light source 30 is totally reflected at both side surfaces of the second groove portion 55 to prevent the light L from leaking to the outside of the light guide sheet 25 from the recessed groove 52.

### Fourth Embodiment

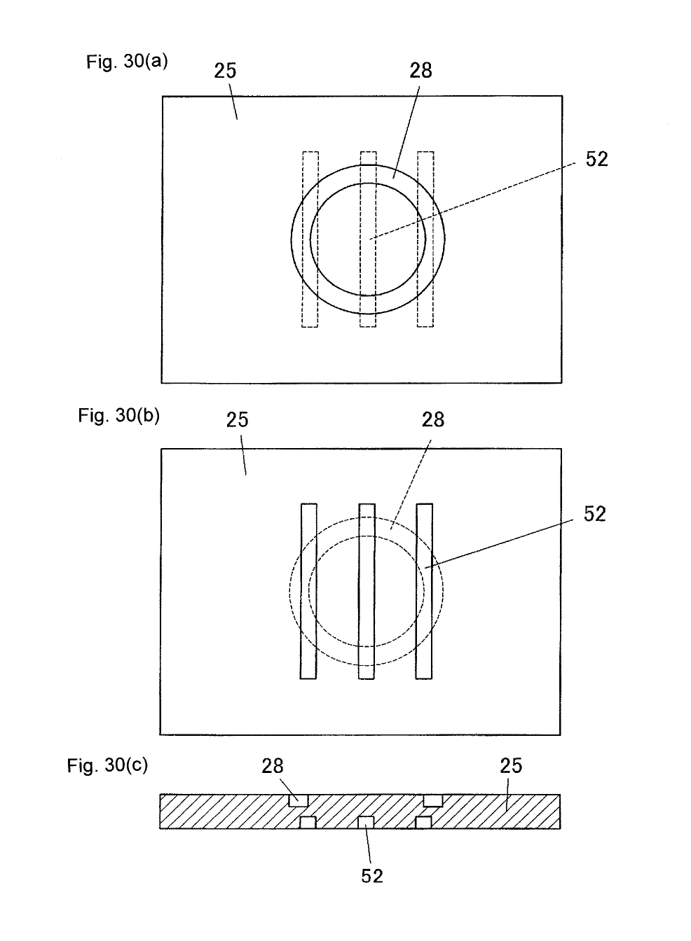

FIGS. 30(a), 30(b), and 30(c) are a plan view, a rear view, and a cross-sectional view showing the light guide sheet 25 used in a switch with lighted key according to a fourth embodiment of the present invention. In this embodiment, the recess is formed on the front and the rear of the light guide sheet 25. That is, the circular ring shaped annular groove 28 is arranged on the front surface of the light guide sheet 25, as shown in FIG. 30(a), and a plurality of recessed grooves 52 are arranged on the rear surface of the light guide sheet 25 facing the annular groove 28, as shown in FIG. 30(b).

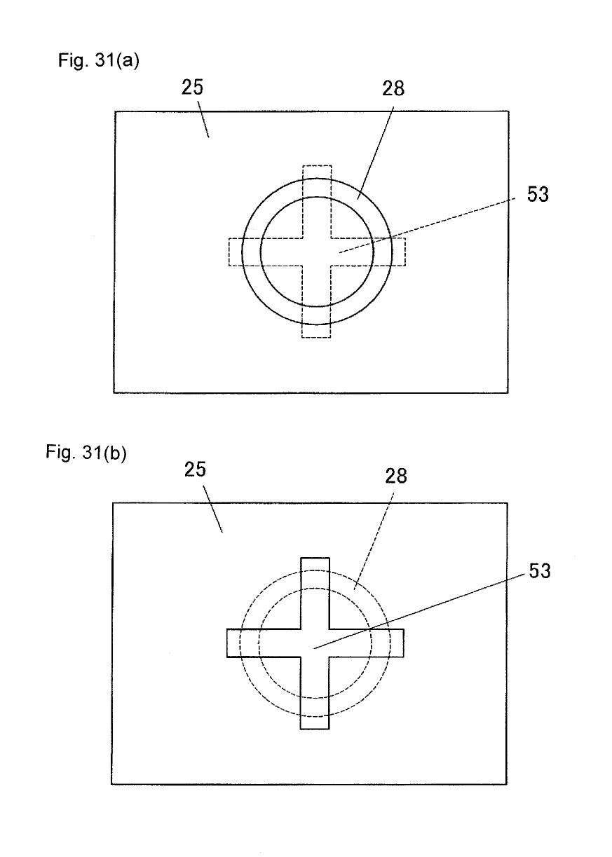

FIGS. 31(a) and 31(b) are a plan view and a rear view showing the light guide sheet 25 according to a variant of the fourth embodiment of the present invention. In this embodiment, the circular ring shaped annular groove 28 is arranged on the front surface of the light guide sheet 25, as shown in FIG. 31(a), and the cross-shaped recessed groove 53 is arranged on the rear surface of the light guide sheet 25 facing the annular groove 28, as shown in FIG. 31(b).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A switch module with lighted key comprising:
a cover sheet having an adhesive layer on a rear surface,
a dome-shaped contact spring adhered on a rear surface of the cover sheet by the adhesive layer,
a substrate including a fixed contact switched to an electrically conducted state or an insulated state with the contact spring, and
a light guide sheet arranged on a front surface side of the cover sheet;
wherein one or more recesses are formed in a region facing the contact spring of at least one of a front surface and a rear surface of the light guide sheet so as not to penetrate toward a surface on an opposite side.

2. The switch module with lighted key according to claim 1, wherein the recess is arranged to be point symmetric with respect to a point corresponding to a center of the contact spring of the light guide sheet.

3. The switch module with lighted key according to claim 1, wherein the recess is arranged to be line symmetric with respect to a virtual line passing through a point corresponding to a center of the contact spring of the light guide sheet.

4. The switch module with lighted key according to claim 1, wherein the recess includes an annular groove of a circular ring shape having a constant width.

5. The switch module with lighted key according to claim 4, wherein an inner diameter of the annular groove is greater than or equal to 0.5 times and smaller than or equal to 0.6 times a diameter of the contact spring.

6. The switch module with lighted key according to claim 4, wherein the annular groove is formed on a surface on a side the switch of the light guide sheet is arranged.

7. The switch module with lighted key according to claim 1, wherein the recess includes a linear recessed groove having a constant width.

8. The switch module with lighted key according to claim 7, wherein the recessed groove is formed on a surface on a side the contact spring of the light guide sheet exists.

9. The switch module with lighted key according to claim 7, wherein the recessed groove has a length of greater than or equal to 0.5 times the diameter of the contact spring.

10. The switch module with lighted key according to claim 4, wherein a groove width of the recess is greater than or equal to 200 μm.

11. The switch module with lighted key according to claim 4, wherein a groove cross-sectional shape of the recess is a trapezoidal shape or a triangular shape.

12. The switch module with lighted key according to claim 4, wherein a width of the groove is greater than a depth of the groove at a groove cross-section of the recess.

13. The switch module with lighted key according to claim 7, wherein the recessed groove is arranged so that a longitudinal direction is parallel to a line segment connecting a position of the recessed groove and a position of a light source.

14. The switch module with lighted key according to claim 7, wherein a groove portion for optical path conversion for changing a direction of light advancing toward a distal end of a recessed groove is arranged at a position closer to a light source than the recessed groove adjacent to the recessed groove.

15. The switch module with lighted key according to claim 7, wherein a groove width of the recess is greater than or equal to 200 μm.

16. The switch module with lighted key according to claim 7, wherein a groove cross-sectional shape of the recess is a trapezoidal shape or a triangular shape.

17. The switch module with lighted key according to claim 7, wherein a width of the groove is greater than a depth of the groove at a groove cross-section of the recess.
